(19) United States
(12) Patent Application Publication
(10) Pub. No.: US 2004/0262171 A1
(43) Pub. Date: Dec. 30, 2004

(54) Container cylinder for a sanitary brush

(76) Inventor: Ming-Hsiao Lai, Chang-Hua Hsien (TW)

Correspondence Address: John S. Egbert, Harrison & Egbert, 7th Floor, 412 Main Street, Houston, TX, 77002, US

(21) Appl. No.: 10/856,952

(22) Filed: Jun. 1, 2004

(30) Foreign Application Priority Data
Jun. 10, 2003 (TW) 092210555

(51) Int. Cl. A45D 44/18; B43K 5/06

(52) U.S. Cl. 206/15.3

(57) ABSTRACT

A modified structure of a container cylinder for a sanitary brush, includes a handle, brush, cover and container cylinder, of which the handle is connected to the brush. The cover is installed between the handle and brush for spacing, while the container cylinder is available with a hollow structure of upper and lower apertures. As the upper and lower nozzles of the container cylinder are subjected to internal edge bonding, only a single machine and mould shall be required, thereby reducing the manufacturing cost and promoting its output and quality in an efficient way. And, as the cover is closely attached to the cylinder, a modified and cost-saving streamline is made available to meet the requirement of this industry.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a container cylinder for a sanitary brush, and more particularly to a container cylinder of improved structure.

### BACKGROUND OF THE INVENTION

The container cylinder for a sanitary brush is widely applied by the general public for its pleasing appearance and sanitation functions. As shown in FIG. 6, the typical container cylinder for a sanitary brush comprises handle 81, brush 82, cover 83 and a container cylinder 84. The cover 83 is installed between the handle 81 and brush 82 for spacing, while the container cylinder 84 is available with a hollow structure of upper nozzle 85 and lower nozzle 86. When you want to put the brush 82 into the container cylinder 84, you have to put the cover 83 on the upper nozzle 85 to avoid the brush 82 falling down or exposure from the lower nozzle 86.

To prevent any incised wound by sharp edge, the upper nozzle 85 and lower nozzle 86 shall be subjected to external edge bonding 87 and internal edge bonding 88 (as shown in FIG. 7). However, with regard to the structure of conventional container cylinder 84 that the upper nozzle 85 and lower nozzle 86 are subjected to external edge bonding 87 and internal edge bonding 88, respectively, it is necessary to firstly process the edge bonding at one end and then displace the edge bonding machine for another one in a time-consuming way. And, as shown in FIG. 8, the upper nozzle 85 is provided with the external edge bonding 87, there is an unsealed space (L) between the cover bottom 89 and the lateral surface of the container cylinder 84. Given the fact that the container cylinder for sanitary brush has become one of popular consumer goods, its price will gradually decline under the market competition. For this reason, it is necessary to save its manufacturing cost and promote its output and quality in an efficient way to meet the demanding requirements of this industry.

Therefore, based upon the above-mentioned disadvantages of container cylinder for a sanitary brush, e.g. lower manufacturing speed, higher cost and unsealing between the cover and cylinder, this industry shall assume the responsibility of making some pioneering R&D for a utility model.

### BRIEF SUMMARY OF THE INVENTION

The present invention can offer an improved efficiency as detailed below.

1. To provide a modified structure of the container cylinder for a sanitary brush.

2. As both the upper and lower nozzles of the container cylinder are available with a structure of internal edge bonding, only a single machine and mould shall be required, thereby reducing the manufacturing cost and promoting its output and quality in an efficient way. And, as the cover is closely attached to the cylinder, a modified and cost-saving streamline is made available to meet the requirements of this industry.

### BRIEF DESCRIPTION OF THE SEVERAL VIEWS OF THE DRAWINGS

FIG. 1 shows a cutaway view of the installed invention.

FIG. 2 shows a local cutaway view of the internal edge bonding.

FIG. 3 shows an amplified local cutaway view of the lid and container cylinder.

FIGS. 4-5 show the installation of the present invention.

FIG. 6 shows a local cutaway view of the said structure.

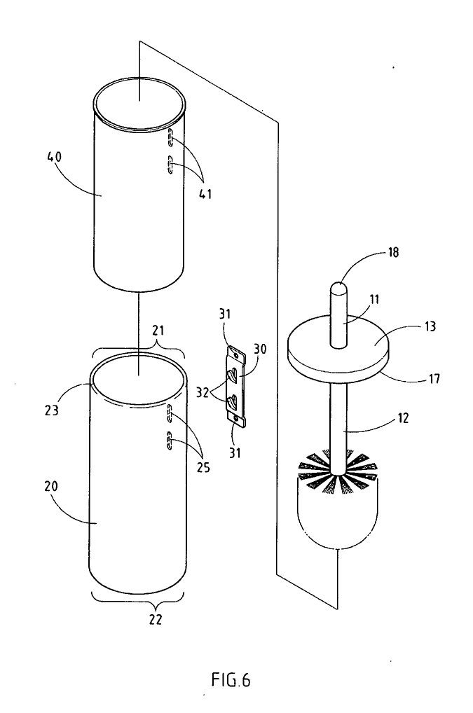

FIG. 7 shows an amplified local cutaway view of the internal and external edge bonding.

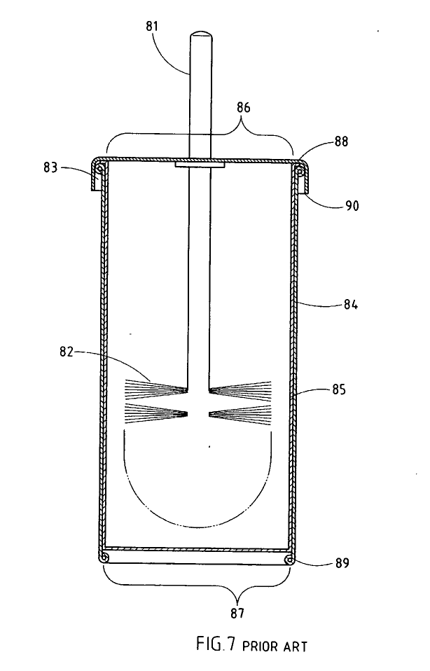

FIG. 8 shows an amplified local cutaway view of the lid and container cylinder.

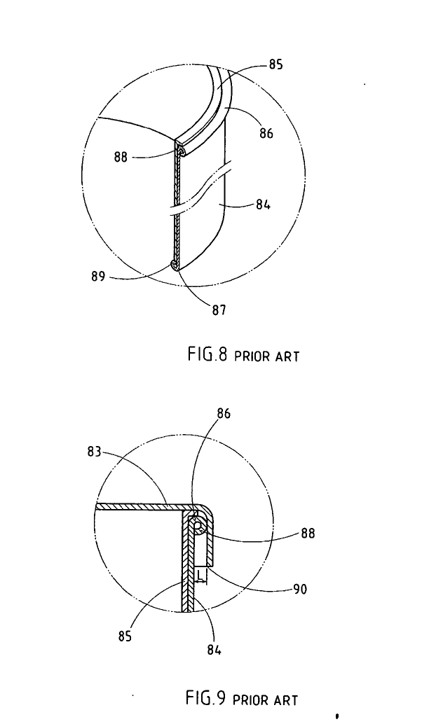

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

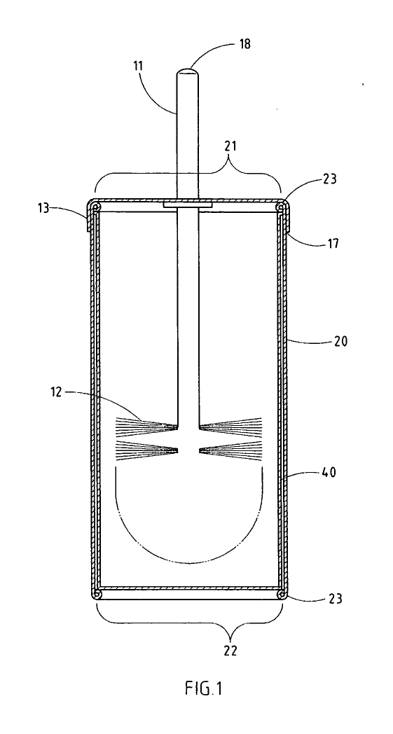

As shown in FIG. 1, a container cylinder for sanitary brush embodied in the present invention comprises: handle 10, brush 20, cover 30 and container cylinder 40, of which the handle 10 is connected to the brush 20. And, the cover 30 is installed between the handle 10 and brush 20 for spacing, while the container cylinder 40 is available with a hollow structure of upper nozzle 41 and lower nozzle 42. When you want to put the brush 20 into the container cylinder 40, you have to put the cover 30 on the upper nozzle 41 of the container cylinder 40 so as to avoid the brush 20 falling down or exposure from the lower nozzle 42 of the container cylinder 40.

As both the upper nozzle 41 and lower nozzle 42 of the container cylinder 40 are available with a structure of internal edge bonding 43, only a single machine and mould shall be required to manufacture the internal edge bonding 43 of the container cylinder 40, thereby reducing the manufacturing cost and promote its output and quality in an efficient way.

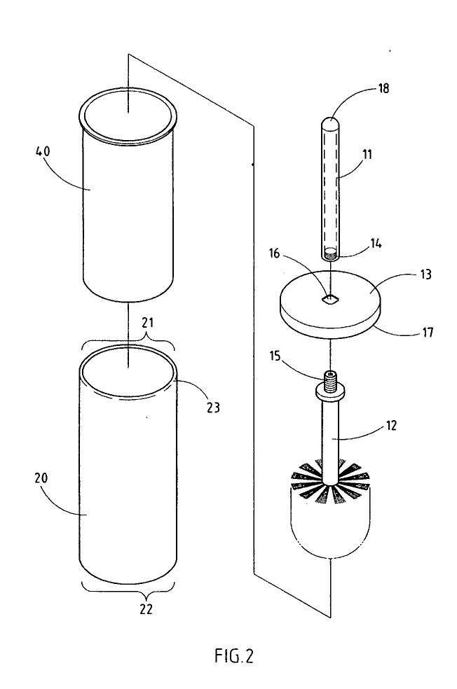

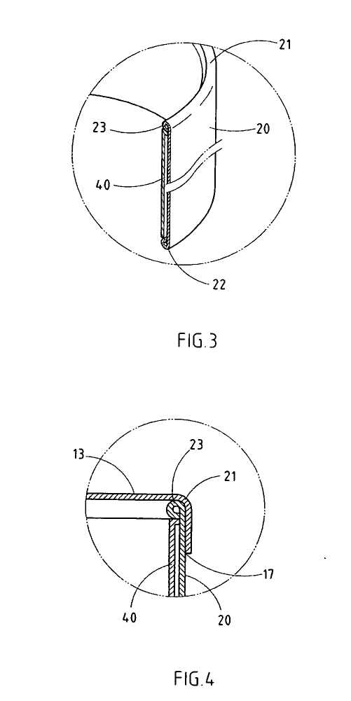

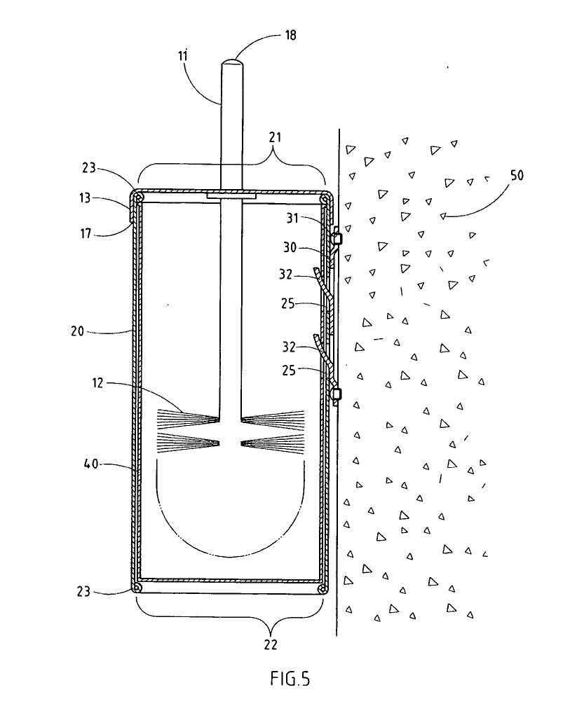

As shown in FIGS. 2-3, when the upper nozzle 41 is subjected to internal edge bonding 43, the cover bottom 31 and lateral surface of the container cylinder 40 are sealed. As shown in FIG. 4, the lateral surface of the container cylinder 40 is provided with a locking hole 44 and a lockset 60 for fixation into the wall 70. When it is fixed into the wall 70, the container cylinder 40 is closely attached to the wall 70 for a lesser space.

As shown in FIG. 5, the container cylinder 40 is provided with a plastic cylinder 50, which is helpful to corrosion protection of the container cylinder 40 as well as cleaning and replacement.

1. A container cylinder for a sanitary brush comprising:
a container cylinder with a hollow structure having upper and lower apertures for upper and lower nozzles respectively;
a brush provided with a handle at one side;
a cover installed between the handle and brush, wherein said cover is placed on the upper nozzle to maintain position of said brush within said container cylinder
wherein said upper and lower nozzles have a structure of internal edge bonding.

2. The container cylinder defined in claim 1, wherein said container cylinder is comprised of a plastic cylinder.

3. The container cylinder defined in claim 1, wherein said container cylinder further comprises a wall-mount device.
